(19) United States
(12) Patent Application Publication
(10) Pub. No.: US 2013/0154363 A1
(43) Pub. Date: Jun. 20, 2013

(54) Method for internally generating electric energy in electric vehicles

(71) Applicant: Jae Hyun Lim, Cresskill, NJ (US)

(72) Inventor: Jae Hyun Lim, Cresskill, NJ (US)

(21) Appl. No.: 13/374,249

(22) Filed: Dec. 19, 2011

(51) Int. Cl. B60L 11/18; H02K 53/00

(52) U.S. Cl. 307/10.1; 74/DIG. 9

(57) ABSTRACT

Disclosed is a method to create an extra electric energy source to power electric batteries while the electric vehicle is in motion. This electric energy source is generated from a separate internally installed component (a specially designed “Eco-Generator”). This component converts the axel shaft rotational energy through a delivery device.

### BACKGROUND OF THE INVENTION

The hybrid electric vehicle (HEV) and the electric vehicle (EV) are currently experiencing a growth in development and demand due to the growing lack of fossil fuels and due to carbon dioxide emissions from exhaust in conventional fuel cars. Therefore, in many countries and local governments, there are many incentives and promotions granted to develop HEVs and EVs in an effort to make them more attractive to the public market.

However, there are many limitations that must be addressed to make HEVs and EVs more efficient. One important limitation is the insufficient capacity of the electric batteries used in electric vehicles. Because there are currently not many electric charging infrastructures (charging stations), there is a great interest to increase the capacity of electric vehicle batteries instead. Increasing its electric capacity would offer significant performance benefits in mileage per complete plug-in charge and make electric vehicles much more reliable.

### BRIEF SUMMARY OF THE INVENTION

This method presents an additional renewable electric energy source for recharging batteries on moving electric vehicles.

This is done by withdrawing _{.}energy from axel shaft rotations to power a separately installed component (a specially designed “Eco-Generator”) internally to the vehicle infrastructure to generate a rechargeable power source.

The key concept of this method is that the mechanical rotational energy from the axel shaft is converted to electric energy while the vehicle is in motion, which recharges the battery. This is a way to supply a continuously recharging source of electricity, which would increase the battery usage ratio per full charge.

### BRIEF DESCRIPTION OF DRAWINGS

This method can be more clearly explained with reference to the following drawings:

FIG. 1 is an illustration of the delivery device connecting the axel shaft to the main shaft of the Eco-Generator.

FIG. 2 is a cross sectional view of the Eco-Generator.

FIG. 3 is an illustration of an electric vehicle's internal recharging system in accordance to the present method.

### DETAILED DESCRIPTION OF THE INVENTION

The vehicle's electric battery supplies power to rotate the axel shafts which all work to move the vehicle by rotating the wheels.

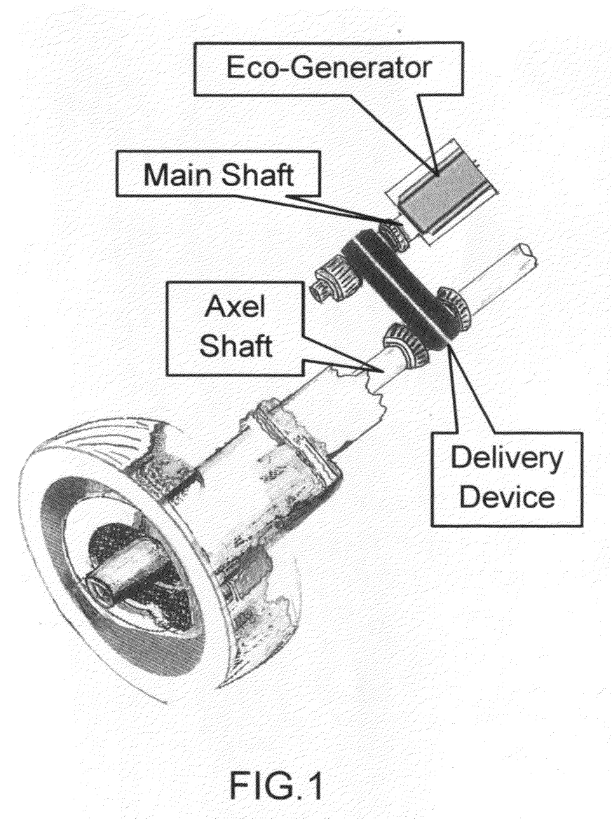

The delivery device in FIG. 1 transfers the rotating axel shaft energy to the main shaft of the Eco-Generator. This delivery device can be composed of a belt, chain, gears, etc.

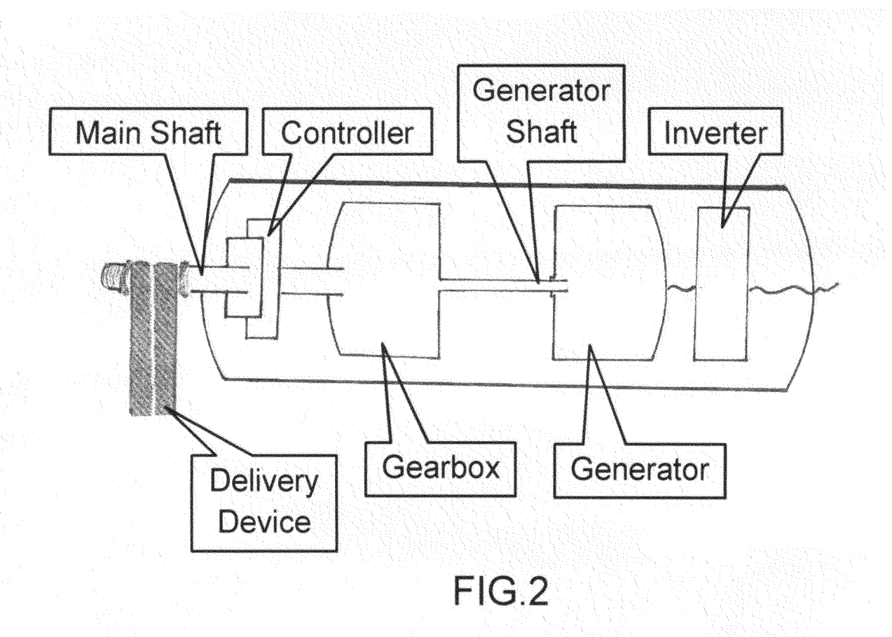

The Eco-Generator as shown in FIG. 2 consists of a controller, a gearbox, a generator, and an inverter. The controller consists of a brake system and a sensor. The brake system manages the rotational speed of the main shaft, which depends on the operator's driving patterns. The sensor regulates the temperature of the Eco-Generator by adjusting the brake system to control the rotational speed of the main shaft. The gearbox transfers the rotational velocity of the main shaft to the generator shaft which would result in a higher rotational velocity. The generator converts the mechanical rotational energy of the generator shaft to electrical energy. Then, the electrical energy, through the inverter, recharges the electric battery.

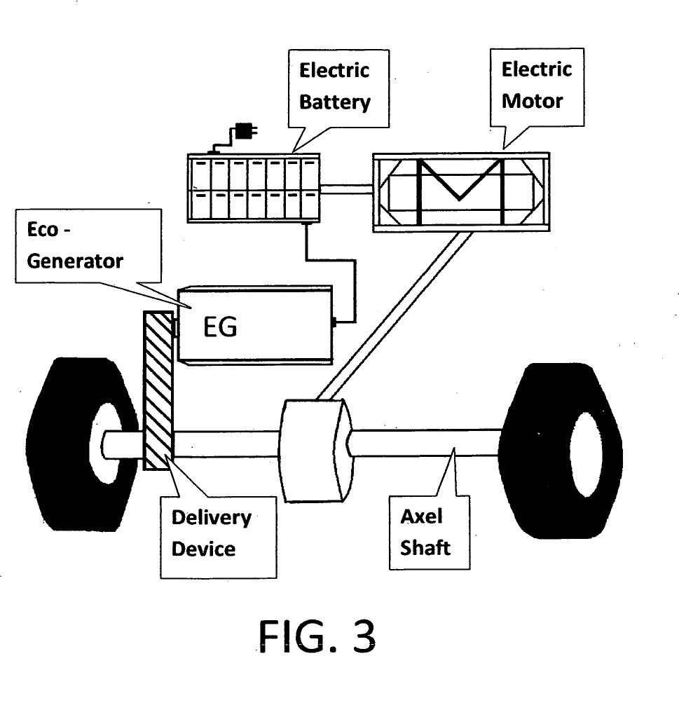

FIG. 3 illustrates the recharging system of this method: the rotating axel shaft delivers the rotational energy to the main shaft of the Eco-Generator through the delivery device in which the resulting electric energy from the Eco-Generator recharges the electric battery and then supplies rotational energy to the axel shaft.

What is claimed is:

1. A method to generate an extra electric energy source to recharge the batteries of electric vehicles in motion by withdrawing the rotational energy from the axel shaft to power a separate generator component (internally installed to the vehicle infrastructure) through a delivery device.
